(19) United States
(12) Patent Application Publication
(10) Pub. No.: US 2026/0237829 A1
(43) Pub. Date: Aug. 13, 2026

(54) PRESSURE EQUALIZATION DEVICE FOR A BATTERY HOUSING

(71) Applicant: ILLINOIS TOOL WORKS INC., Glenview, IL (US)

(72) Inventors: Fulvio Pacifico Yon, Glenview, IL (US); Ilaria Giacomelli, Glenview, IL (US)

(21) Appl. No.: 19/155,782

(22) PCT Filed: Oct. 24, 2023
(86) PCT No.: PCT/IB2023/000638

§ 371 Date: Aug. 12, 2025

(30) Foreign Application Priority Data
Feb. 22, 2023 (EP) 23157922.8
Mar. 17, 2023 (EP) 23162552.6
Aug. 15, 2023 (WO) PCT/IB2023/000254

(51) Int. Cl. H01M 50/325

(52) U.S. Cl. CPC H01M 50/325

(57) ABSTRACT

The invention relates to a pressure equalization device (1, 101, 301) for a battery housing. The device comprises a cage (2, 102, 302) forming a fluid passage (23, 123, 323) and a valve member (3, 103, 203, 303) covering the fluid passage. The valve member comprises a hole (33, 133, 233, 333) through its thickness and a membrane (34, 134, 234, 334) attached to the valve member and covering the hole. The membrane is configured to equalize, when in use, the pressure inside the battery housing with the ambient pressure outside the battery housing, while the valve member is configured to move or distort reversibly at a preset pressure difference between the inside and the outside of the battery housing to prevent overpressure inside the battery housing.

### TECHNICAL FIELD OF THE INVENTION

The invention relates to the field of pressure equalization devices, making it possible to compensate for the variation in pressure inside a battery and to systematically release the pressure in the event of overpressure (for example, by means of a degassing device).

### TECHNICAL BACKGROUND

Patent EP3385584, filed by Freudenberg, describes the use of a pressure compensation element for accumulators. More specifically, this element combines the pressure compensation function under normal operating conditions with overpressure reduction for emergency degassing.

### SUMMARY OF THE INVENTION

The invention relates to a pressure equalization device for a battery housing.

The device can comprise a valve member.

The invention also relates to a valve member, for example for a or the pressure equalization device.

The device can comprise a cage. The cage can form a fluid passage. The valve member can comprise a flexible umbrella valve member. The valve member can cover the fluid passage. The valve member can comprise a hole, for example through its thickness. The valve member can comprise a membrane that can be attached to the valve member and/or can cover the hole.

The membrane can be configured to equalize, when in use, the pressure inside the battery housing with the ambient pressure outside the battery housing. The valve member can be configured to move or distort reversibly, for example at a preset pressure difference between the inside and the outside of the battery housing, to prevent overpressure inside the battery housing.

The invention also relates to a pressure equalization device for a battery housing, the device comprising a cage forming a fluid passage, and a valve member covering the fluid passage, the valve member comprising a hole through its thickness and a membrane attached to the valve member and covering the hole, in which the membrane is configured to equalize, when in use, the pressure on the inside of the battery housing with the ambient pressure outside the battery housing while the valve member is configured to move or distort reversibly at a preset pressure difference between the inside and the outside of the battery housing, to prevent overpressure inside the battery housing.

The invention thus provides a pressure equalization device that is both compact and enables a high degassing flow.

The device can always be open to prevent any obstruction of the pressure equalization and overpressure prevention functions.

The device can comprise a lid. The lid can cover the cage. The lid can fit loosely onto the cage or a tubular wall of the cage, for example so that air can flow between them.

The lid can be incapable of ensuring the seal against the cage.

The lid can be substantially fixed and/or non-removable relative to the cage. For example, the lid is substantially fixed and/or non-removable relative to the cage when the lid is mounted on and/or around the cage.

In some exemplary embodiments, the device and/or the cage does not have a lid. The device and/or the cage can have no lid or be lid-free, for example so that the cage is uncovered and/or open.

The invention also relates to a valve member for a pressure equalization device with a fluid passage designed to be covered by the valve member, the valve member comprising a hole through its thickness and a membrane attached to the valve member and covering the hole, in which the membrane is configured to equalize, when in use, the pressure on the inside of the battery housing with the ambient pressure outside the battery housing while the valve member is configured to move or distort reversibly at a preset pressure difference between the inside and the outside of the battery housing, to prevent overpressure inside the battery housing.

The membrane can also be permeable to gases and impermeable to fluids, for example to enable air to flow through it so as to equalize the pressure inside the battery housing with the ambient pressure outside the battery housing. The membrane can be built into or overmolded on the valve element.

Moreover, all of the holes can be covered with one membrane or each hole can be covered with a respective membrane.

Alternatively, the membrane can be configured to move or distort reversibly, for example to equalize the pressure inside the battery housing with the ambient pressure outside the battery housing.

The valve member can comprise a disc. The valve member or disc can comprise a canopy. At least part of the hole can be next to the disc or the canopy. At least part of the hole can at least partially surround the disc or the canopy. The hole can also extend through the disc or the canopy. The disc or the canopy can be rigid or flexible.

The invention also relates to a valve member for a pressure equalization device, the valve member comprising a rigid or flexible disc or canopy with a hole extending through the disc or the canopy and a membrane attached to the valve member and covering the hole.

The canopy can extend radially from the rod, for example to cover the fluid passages.

Advantageously, the hole is one of two or more holes through the disc or the canopy. Each of the holes can be covered by the membrane or a respective membrane.

The valve member can comprise a rod. The canopy can extend radially from the valve member.

The disc or the canopy can comprise ridges, for example reinforcement ridges. The ridges can surround the hole or holes.

The rod can be solid. At least part of the rod can comprise a non-circular cross section. At least part of the rod can comprise a substantially cruciform or Y-shaped or star-shaped cross section.

The disc or the canopy can be flat or curved. The disc or the canopy can be compressed or pushed to a closed position, for example in which it covers the fluid passage.

Advantageously, the cage can comprise a central support. The fluid passage can be one of two or more fluid passages around the central support. The valve member can comprise a flexible umbrella valve member. The valve member can comprise a rod, which can be connected to the central support.

Moreover, the disc can be pushed by a pressure means, such as a spring, to a closed position, for example in which it covers the fluid passage. The disc or the cage can comprise a gasket or sealing means, for example a peripheral gasket or sealing means. The gasket or the sealing means can extend over the edge of the fluid passage(s) or of the disc. The gasket or the sealing means can be configured to seal and/or create a seal between the disc and the cage, for example when the disc is in the closed position.

The disc or the canopy can be configured to move or distort reversibly at a preset pressure difference between the inside and the outside of the battery housing to prevent overpressure inside the battery housing.

In addition, the cage can comprise a lip and/or a gasket. The gasket can be spaced apart from the lip. The gasket and the lip can be configured to lock, when in use, a wall of the battery housing between them, for example to seal the cage in a hole in the battery housing.

The cage can also comprise a bayonet coupling. The bayonet coupling can have two or more flanges, each of which can form part of a lip.

The cage can comprise a valve seat. The valve member or the disc or the canopy on the valve member can engage, for example sealingly, against the valve seat when the disc or the canopy covers the fluid passages. The cage can comprise a sealing member. The sealing member can comprise the gasket and/or the valve seat. The gasket can be connected to the valve seat, for example by one or more bridging columns.

The disc or the canopy can comprise one or more lip seals, which can be configured to engage in the valve seat. The lip seal or seals can comprise a pair of lip seals, which can be spaced apart from each other; for example, the lip seal or seals can comprise a pair of spaced lip seals.

The gasket and/or the valve seat and/or the sealed part can be incorporated into the cage, for example by a overmolding process. The gasket can be located on a first side of the cage, for example a lower side. The valve seat can be located on a second side of the cage, for example an upper side, which can be opposite to the first side. The bridging columns can extend across the cage.

Advantageously, the device can comprise a lid, which can be mounted on the cage. The lid can be movable, for example between an open configuration, in which air can escape from the housing when in use, and a closed configuration, in which the housing is sealed.

The pressure means that pushes the disc toward the closed position can be locked between the disc and the lid. The disc and/or the lid can comprise a connector, for example for connecting to one end of the spring. The disc can comprise a protrusion, which can be accommodated by one end of the pressure means. The lid can comprise a housing or a socket, for example in which the other of the ends of the pressure means can be accommodated. The housing or the socket on the lid can surround at least part of the protrusion on the disc. The lid can also comprise a protrusion that can be accommodated by one end of the pressure means, and/or the disc can comprise a housing or a socket, for example in which the other end of the pressure means can be accommodated and/or the housing or socket on the disc can surround at least part of the protrusion on the lid.

The lid can be rotated between the open and closed configurations or positions. At least one of the lid and of the cage can comprise a formation, for example an inclined, helical or screw-shaped formation. The formation can cooperate with a formation on the other of the lid and of the cage to cause the lid to move relative to the cage when it is rotated between the open and closed configurations or positions.

The lid can be screwed in between the open and the closed configurations or positions. The device can comprise sealing means on one or both of the lid and/or of the cage, for example, that ensure the seal on the housing when the lid is in the closed configuration or position.

The lid can comprise one or more windows. The cage can comprise one or more windows. The or each window in the lid can be aligned with the corresponding window or windows in the cage, for example when the lid is in the open position. The or each window in the lid can be unaligned or offset relative to the corresponding window or windows in the cage, for example when the lid is in the closed position. The device can comprise a gasket, for example a window gasket, that can be configured to seal the fluid communication between the windows, for example when the lid is in the closed position.

For the avoidance of doubt, all the features described herein also apply to any aspect of the invention.

As part of this application, it is expressly provided that the various aspects, embodiments, examples and alternatives disclosed in the preceding paragraphs, in the claims and/or in the following description and drawings, and in particular the individual features thereof, can be taken separately or in any combination. In other words, all embodiments and/or features of any embodiment can be combined in any way, unless these features are incompatible.

To avoid any ambiguity, the terms “can”, “and/or”, “for example”, and any other similar term used in the present document are to be interpreted as not limiting, such that any feature thus described is not necessarily required to be present. Indeed, any combination of optional features is expressly foreseen without departing from the scope of the invention, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

### BRIEF DESCRIPTION OF THE FIGURES

Other features and advantages of the invention will become apparent from the following detailed description, which will be understood in reference to the appended drawings, in which:

FIG. 1 illustrates a pressure equalization device for a battery housing according to an exemplary embodiment of the invention;

FIG. 2 illustrates the device in FIG. 1 without its top cover;

FIG. 3 illustrates a side view from below of the device in FIG. 1, showing the engagement between the lid and the tubular wall;

FIG. 4 illustrates a perspective view from below of the device in FIG. 1;

FIG. 5 illustrates a cross-sectional view of the device in FIGS. 1 to 4, seen along the main axis of the device;

FIG. 6 illustrates a cross-sectional view of a pressure equalization device for a battery housing according to another exemplary embodiment of the invention, seen along the main axis of the device;

FIG. 7 illustrates a perspective view of the gasket section of the device shown in FIG. 6;

FIG. 8 illustrates a cross-sectional view of the device in FIG. 6 through a plane perpendicular to the main axis of the device;

FIG. 9 illustrates a cross-sectional view of a valve member for a pressure equalization device for a battery housing according to another exemplary embodiment of the invention;

FIG. 10 illustrates a side view from below of the valve member in FIG. 9;

FIG. 11 illustrates a pressure equalization device for a battery housing according to another exemplary embodiment of the invention;

FIG. 12 illustrates the device in FIG. 11 without its top cover;

FIG. 13 illustrates a side view from below of the device in FIG. 11, showing the engagement between the lid and the tubular wall;

FIG. 14 illustrates a perspective view from below of the device in FIG. 11;

FIG. 15 illustrates a cross-sectional view of the device in FIGS. 11 to 14;

FIG. 16 illustrates a cross-sectional view of a pressure equalization device for a battery housing according to another exemplary embodiment of the invention; and

FIG. 17 illustrates a perspective view from below of the device in FIG. 16.

### DETAILED DESCRIPTION OF THE INVENTION

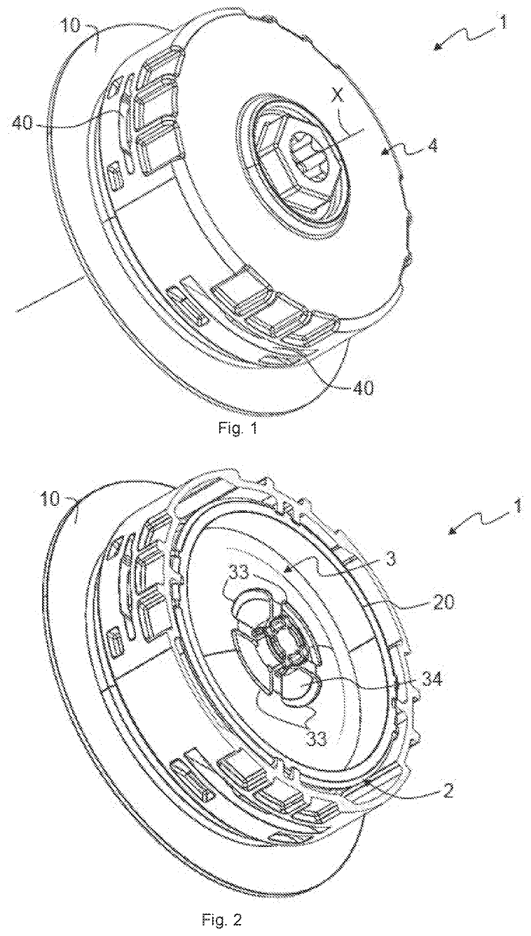

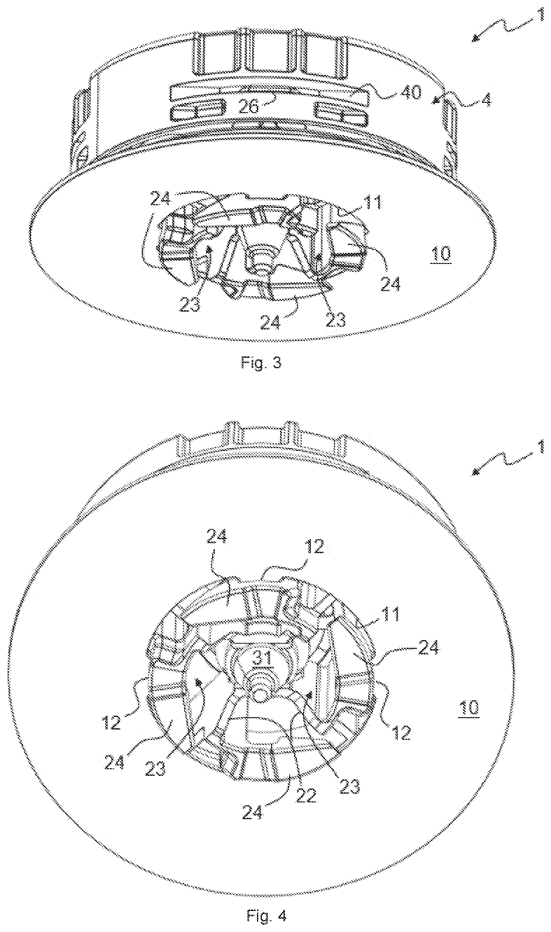

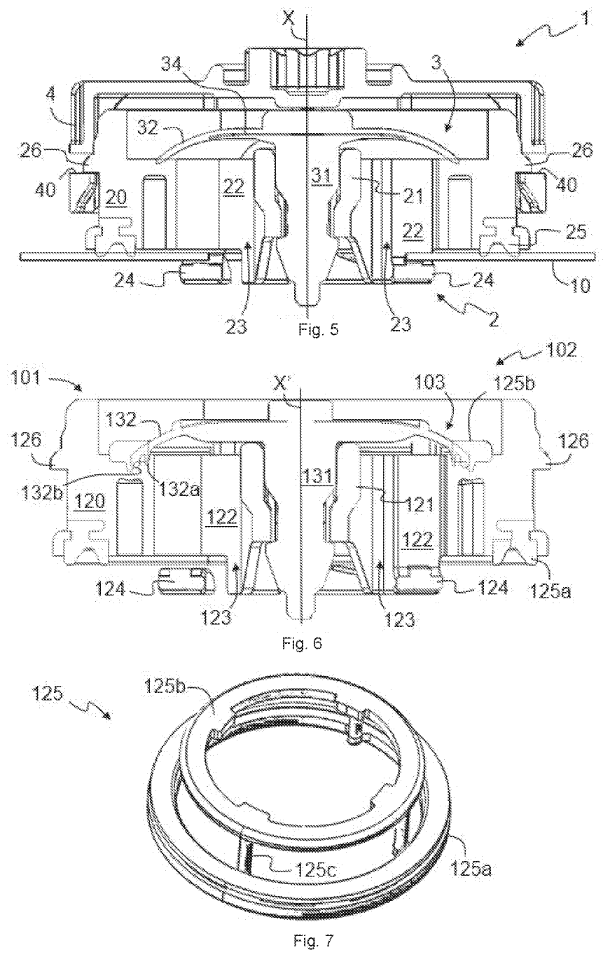

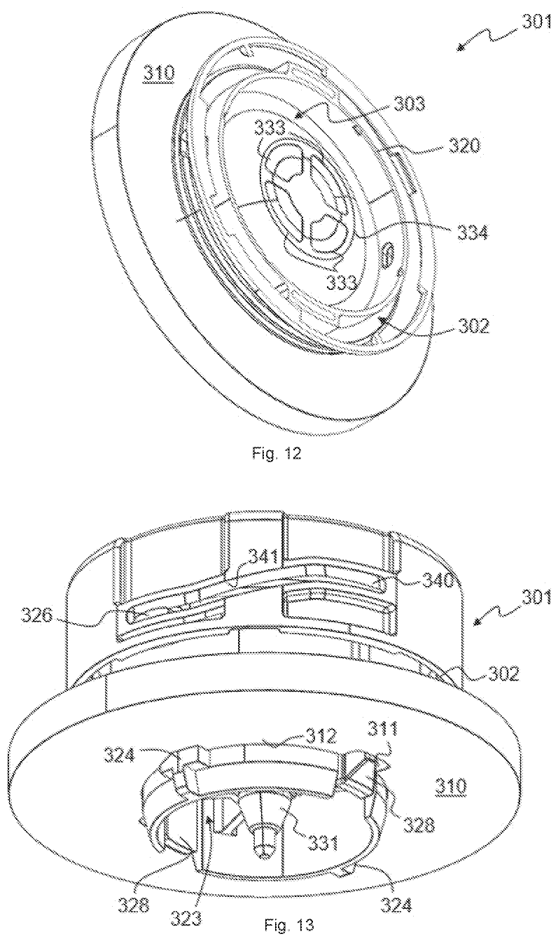

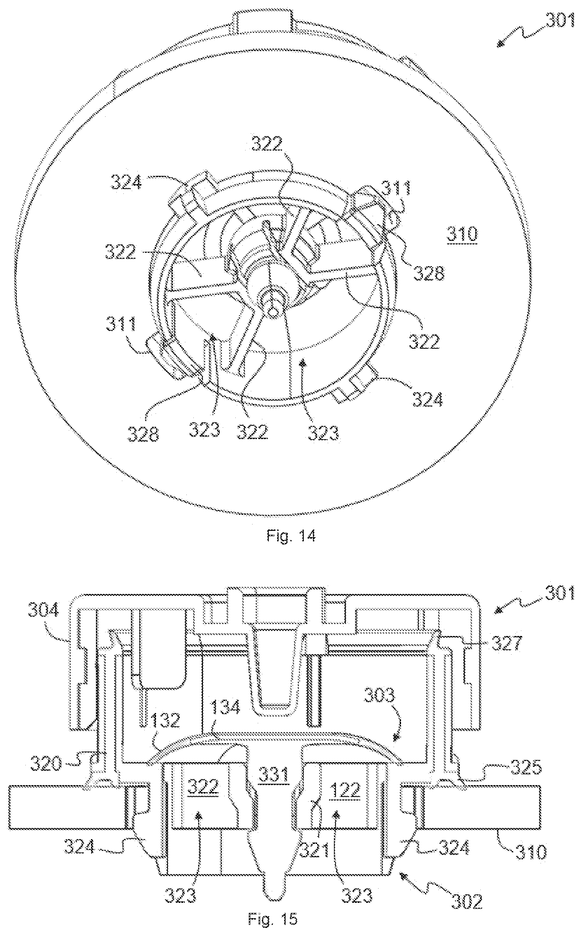

Different aspects of different embodiments of the invention are described in more detail below, in reference to FIGS. 1 to 14.

FIGS. 1 to 5 show a pressure equalization device 1 according to an exemplary embodiment, which is mounted on the wall of a battery housing 10 (only part of which is shown). The device 1 comprises a primary axis X, a cage 2, a valve member 3 that is mounted in the cage 2, and a lid 4 that is mounted on the cage 2. The wall of the battery housing 10 comprises a hole 11 inside which the device 1 is mounted.

The cage 2 comprises a tubular wall 20, a central support 21 connected to the tubular wall 20 by four radial walls 22. Fluid passages 23 are formed between the radial walls 22, providing fluid communication between the inside of the wall of the battery housing 10 and the inside of the cage 2.

Four radial flanges 24 protrude outward from the lower end of the radial walls 22. The radial flanges 24 cooperate with four radial tabs 12 on the wall of the battery housing 10 to provide a bayonet coupling for securing the device 1 in the hole 11 in the wall of the battery housing 10. A gasket 25 depends from the tubular wall 20 and the radial flanges 24 form an assembly with a lip, such that the wall of the battery housing 10 is locked between the lip and the gasket 25.

The cage 2 is thus assembled in the hole 11, which is formed on the top of the battery, with a quarter-tum fastening system. Such a solution enables the available space in the hole 11 to be opened up to the maximum extent, thereby optimizing the flow of fluid through the fluid passages 23 in the cage 2. Such a profile with a quarter-tum configuration to be attached to the wall of the battery housing 10 thus enables optimum flow to be achieved to vent the pressure inside the battery by opening up the hole 11 in the battery housing to the maximum extent.

The lid 4 surrounds the tubular wall 20 of the cage 2 and covers its open end. The lid 4 comprises slots 40 that engage with protrusions 26 on the tubular wall 20 to provide a snap-fit connection between the lid 4 and the tubular wall 20. The lid 4 fits loosely onto the tubular wall 20 so that air can flow between them.

The valve member 3 comprises a rod 31 connected to the central support 21 and a canopy 32 extending radially from the rod 31, which covers the fluid passages 23. The valve member 3 is thus an umbrella valve member 3. The canopy 32 preferably has a domed shape and is made of a flexible material so as to increase the closing tension. According to one variant, the canopy 32 has a flat shape. The umbrella valve member 3 can be made of damping material with a high-strength polytetrafluoroethylene (PTFE) membrane.

The canopy 32 comprises four holes 33 through its thickness, which are covered by a membrane 34. The membrane 34 is permeable to gases and impermeable to fluids to enable air to flow through so as to equalize the pressure inside the battery housing 10 with the ambient pressure outside the battery housing 10.

Preferentially, the membrane 34 is overmolded into the flexible umbrella valve member 3. Alternatively, the holes 33 can be covered by a respective membrane 34. In certain exemplary embodiments, the membrane 34 can be impermeable to air and can be designed to flex sufficiently to enable some pressure equalization.

When in use, the air inside the battery housing is equalized by the air passing through the membrane 34. If the pressure inside the battery housing exceeds a preset threshold, the canopy 32 on the umbrella valve member 3 is forced to flex away from the fluid passages 23. This allows highly pressurized air to be expelled from the battery housing to prevent overpressure.

When in operation, the present invention thus enables two pressure equalization functions to be performed. A first function, referred to as the degassing function, in which the canopy 32 on the valve member 3 is distorted by the high pressure from the battery, which is the case in a thermal runaway situation (emergency) and in which degassing must take place within a very short period of time, otherwise the battery will explode.

A second function, referred to as the venting function, in which the membrane 34 acts as a filter that compensates for variations in air pressure to keep the pressure inside the battery equal to the outside pressure. The membrane 34 can be a technical fabric (PTFE) that is impermeable to fluids but not to air. The membrane is therefore suitable for allowing air to pass through at low flow rates, thereby enabling the venting function.

The valve member 3, which is of the valve type, enables the pressure variation inside the battery to be compensated and the pressure to be released systematically (emergency degassing valve). In other words, the valve member 3 enables venting to equalize the internal pressure with the outer pressure, quick degassing when the internal pressure is high (emergency), and sealing against high water pressure from the outside.

Referring now to FIGS. 6 to 8, a pressure equalization device 101 according to a second exemplary embodiment can be seen, which is similar to the first exemplary embodiment in that similar features are marked with similar numbers incremented by 100.

The pressure equalization device 101 according to this exemplary embodiment differs from the one in the first exemplary embodiment in that it comprises a sealing member 125 with a gasket 125a, similar to the gasket 25 in the first exemplary embodiment, and a valve seat 125b against which the canopy 132 on the valve member 103 sealingly engages under normal conditions. Moreover, the canopy 132 also comprises a pair of spaced lip seals 132a, 132b, which are configured to engage in the valve seat 125b.

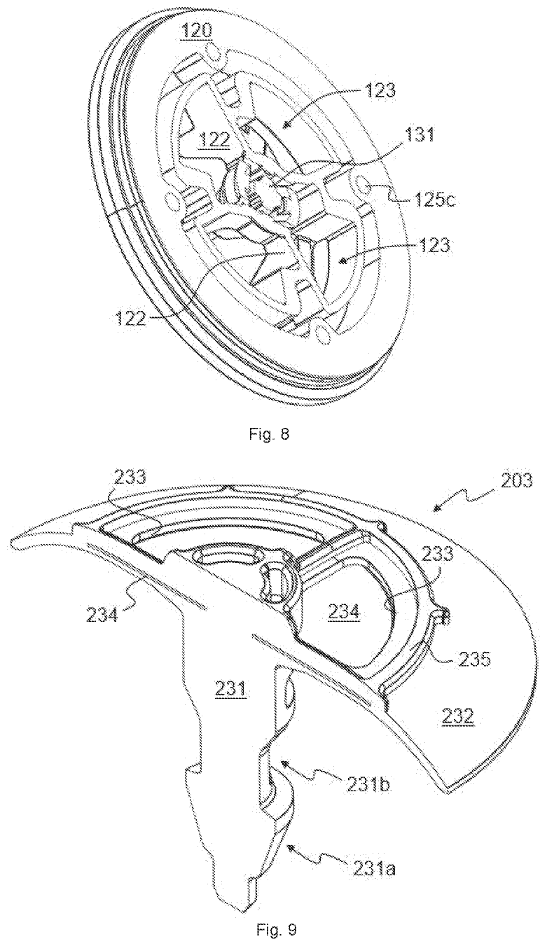

The gasket 125a is connected to the valve seat 125b by four bridging columns 125c and is integrally formed with the cage 102. More specifically, and as is more clearly shown in FIG. 8, the bridging columns 125c extend through holes in the cage 102, which are parallel to the primary axis X′. The sealing member 125 is preferably molded onto and into the cage 102 using a two-step overmolding process. Alternatively, the gasket 125a and the valve seat 125b can be formed as separate components and mounted on the cage 102.

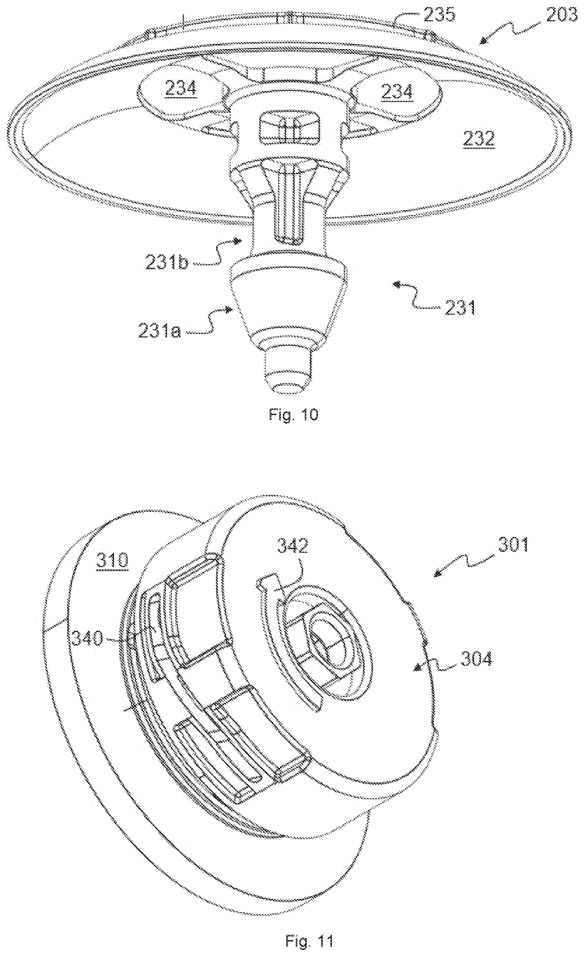

Referring now to FIGS. 9 and 10, a valve member 203 according to a third exemplary embodiment can be seen, which is similar to the first exemplary embodiment in that similar features are marked with similar numbers incremented by 200. The valve member 203 according to this exemplary embodiment differs from the one in the first exemplary embodiment in that the canopy 232 incorporates reinforcing ridges 235 surrounding the holes 233.

As is more clearly shown in FIGS. 9 and 10, the rod 231 comprises a tapered end 231a and a narrowed part 231b. The valve member 203 is mounted on a cage 2, 102 by inserting the tapered end 231a of the rod 231 into the central support 21, 121 and forcing the rod 231 into the central support 21, 121 until the tapered end 231a protrudes from the other end and the central support 21, 121 is locked in the tapered part 231b. Other arrangements are also possible.

Referring now to FIGS. 11 to 15, a pressure equalization device 301 according to a fourth exemplary embodiment can be seen, which is similar to the first exemplary embodiment in that similar features are marked with similar numbers incremented by 300. The pressure equalization device 301 according to this exemplary embodiment differs from the one in the first exemplary embodiment in that the lid 304 can be rotated between the open and closed positions.

More specifically, the tubular wall 320 comprises a gasket 327 around its open end, and each of the slots 340 in the lid 304 comprises a helical segment 341. These helical segments 341 cooperate with the protrusions 326 on the tubular wall 320 to move the gasket 327 toward and away from the lid 304 during rotation.

As a result, the rotation of the lid 304 in the direction illustrated by the arrow 342, shown in FIG. 11, pulls the lid 304 further onto the tubular wall 320, thereby creating a sealed connection between them. This configuration can be advantageous when the battery housing needs to be pressure tested. More specifically, the open position is used for venting/degassing (normal operation) and the closed position to perform the 100% air leak test of the battery housing.

In this exemplary embodiment, the bayonet coupling comprises only two flanges 324, but it also comprises a pair of spring-loaded lock stops 328. The tabs 312 protruding into the hole 311 extend over most of the edge, such that the lock stops 328 snap into place between the tabs 312, thereby keeping the cage 302 from rotating when the lid 304 is turned relative to the cage.

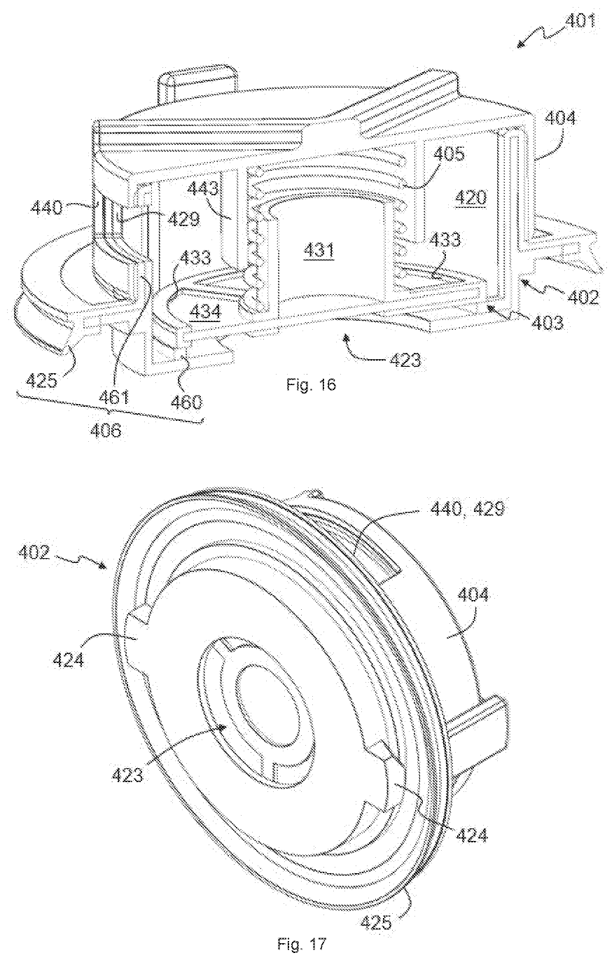

Referring now to FIGS. 16 and 17, a pressure equalization device 401 according to a fifth exemplary embodiment is shown, which is similar to the fourth exemplary embodiment in that similar features are marked with similar numbers incremented by 100. The pressure equalization device 401 according to this exemplary embodiment differs from the one in the fourth exemplary embodiment in that the umbrella valve member 303 is replaced by a disc 403 and that rotating the lid 404 selectively aligns the windows 440, 429 through the lid 404 and the tubular wall 420.

The disc 403 has holes 433 in its thickness, which are covered by an overmolded membrane 434, and a tubular wall 431 protrudes from the center of the disc 403. The lid 404 also comprises a depending tubular wall 443, which is aligned with and surrounds the tubular wall 431 of the disc 403. The device 401 comprises a spring 405, one end of which surrounds the tubular wall 431 of the disc 403 and the other end of which is accommodated in the tubular wall 443 of the lid 404. The spring 405 pushes the disc 403 to a closed position in which it covers the fluid passage 423.

In this exemplary embodiment, a sealing material 406 is molded onto portions of the cage 402. More specifically, the sealing material 406 comprises the gasket 425 which depends from the tubular wall 420 and a disc gasket 460 surrounding the fluid passage 423, which engages with the disc 403 when in the closed position. The sealing material 406 also comprises a window gasket 461 surrounding the window 429 through the cage 402.

As a result, the fluid can flow from the battery housing through the fluid passage 423, through the membrane 434 (or between the cage 402 and the disc 403 when it is moved) and out through the windows 429, 440 when the lid 404 is in the open position (illustrated in FIG. 16). However, when the lid 404 is rotated such that the windows 429, 440 are no longer aligned, the window gasket 461 hermetically seals the fluid communication during a 100% air leak test of the battery housing.

The person skilled in the art will be aware that several variants of the aforementioned embodiments are conceivable without departing from the scope of the invention.

Throughout the description and claims of this specification, the words “comprise” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification should be understood to include the plural as well as the singular, unless the context requires otherwise.

Any features, integers, characteristics, compounds or groups described in connection with a particular aspect, embodiment or example of the invention are to be understood as being applicable to any other aspect, embodiment or example described herein, unless inconsistent therewith. All of the features disclosed in this specification (including the claims, abstract and accompanying drawings), and/or all of the steps of a method or of a process thus disclosed, may be combined in any combination other than combinations in which at least some of such features and/or steps are mutually exclusive. The invention is not limited to the details of all of the preceding embodiments. The invention extends to any new feature or any new combination of the features disclosed in this specification (including the claims, abstract and accompanying drawings), or to any new feature or any new combination of the steps of any method or process thus disclosed.

The reader's attention is drawn to all papers and documents that have been filed concurrently or prior to this specification in connection with this application and that are open for public inspection with this specification, and the content of all such papers and documents is incorporated herein by reference.

1. A pressure equalization device for a battery housing, the device comprising:
a cage forming a fluid passage; and
a valve member covering the fluid passage, the valve member comprising a hole through its thickness and a membrane attached to the valve member and covering the hole,
wherein the membrane is configured to equalize, when in use, pressure inside the battery housing with ambient pressure outside the battery housing
while the valve member is configured to move or distort reversibly at a preset pressure difference between an inside and an outside of the battery housing to prevent overpressure inside the battery housing.

2. The pressure equalization device according to claim 1, wherein the device is always open to prevent any obstruction of the pressure equalization and overpressure prevention functions.

3. The pressure equalization device according to claim 1 comprising a lid covering the cage.

4. The pressure equalization device according to claim 3, wherein the lid fits loosely on a tubular wall of the cage so that air can flow between them.

5. The pressure equalization device according to claim 3, wherein the lid is incapable of ensuring a seal against the cage.

6. The pressure equalization device according to claim 3, wherein the lid is substantially fixed and/or non-removable relative to the cage.

7. The pressure equalization device according to claim 1, wherein the membrane is permeable to gases and impermeable to fluids to enable air to flow through it so as to equalize the pressure inside the battery housing with the ambient pressure outside the battery housing.

8. The pressure equalization device according claim 1, wherein the cage comprises a central support and the fluid passage is one of two or more fluid passages around the central support, in which the valve member comprises a rod connected to the central support and a canopy extending radially from the rod to cover the fluid passages.

9. The pressure equalization device according to claim 8, wherein the hole is one of two or more holes through the canopy, each of which is covered by the membrane or a respective membrane.

10. The pressure equalization device according to claim 8, wherein the cage comprises a valve seat against which the canopy sealingly engages when the canopy covers the fluid passages.

11. The pressure equalization device according to claim 10, wherein the canopy comprises a pair of spaced lip seals, which are configured to engage in the valve seat.

12. The pressure equalization device according to claim 10, wherein the cage comprises a lip and a gasket spaced apart from the lip that are configured to lock, when in use, a wall of the battery housing between them to hermetically seal the cage in a hole in the battery housing.

13. The pressure equalization device according to claim 12, wherein the gasket is connected to the valve seat by bridging columns that extend through the cage.

14. The pressure equalization device according to claim 12, wherein the cage comprises a bayonet coupling with two or more flanges each forming part of the lip on the cage.

15. A valve member for a pressure equalization device according to claim 1, wherein the valve member comprises rigid or flexible disc or canopy with a hole that extends through the disc or the canopy and a membrane attached to the valve member and covering the hole.

16. The valve member according to claim 15, comprising a rod from which the disc or the canopy radially extends, in which at least part of the rod is solid or comprises a non-circular cross-section.

17. The valve member according to claim 15 wherein the disc or the canopy comprises reinforcing ridges surrounding the hole or holes.
